(19) United States
(12) Patent Application Publication
(10) Pub. No.: US 2011/0143313 A1
(43) Pub. Date: Jun. 16, 2011

(54) DENTAL IMPLANT DEVICE

(76) Inventors: Cheng-Hsien Tsai, Yongkang City (TW); Hsin-Wu Mi, Danshuei Township (TW)

(21) Appl. No.: 12/708,009

(22) Filed: Feb. 18, 2010

(30) Foreign Application Priority Data
Dec. 16, 2009 (TW) 098143112

(51) Int. Cl. A61C 8/00

(52) U.S. Cl. 433/141

(57) ABSTRACT

A dental implant device is adapted for use in dental implant operations to engage the dental prosthesis. The dental implant device includes a hollow main body and an external thread. The hollow main body has top and bottom ends, an inner peripheral surface disposed between the top and bottom ends and defining a through hole extending through the top and bottom ends, and an outer peripheral surface disposed between the top and bottom ends and surrounding the inner peripheral surface. The external thread is provided on the outer peripheral surface of the main body.

### CROSS-REFERENCE TO RELATED APPLICATIONS

This application claims priority of Taiwanese application no. 098143112, filed on Dec. 16, 2009

### BACKGROUND OF THE INVENTION

1. Field of the Invention

The invention relates to a dental implant device, more particularly to a dental implant device adapted for use in dental implant operations to engage the dental prosthesis.

2. Description of the Related Art

Referring to FIG. 1, a conventional dental implant device 1 made of titanium is implanted in a patient's alveolar bone 100 to engage the dental prosthesis (not shown) in dental implant operations. The dental implant device 1 comprises a partially hollow main body formed with a notch 111 to engage the dental prosthesis, and an external thread 12 formed on an outer peripheral surface of the main body 11 for engaging the alveolar bone 100.

However, the material of the conventional dental implant device 1 made of biocompatible metal (i.e., titanium) is still significantly different from that of the alveolar bone 100, which results in difficulty in integration between the conventional dental implant device 1 and the alveolar bone 100. After the implantation, it takes 3 to 6 months for the alveolar bone 100 to grow to be firmly connected to the conventional dental implant device 1 until the dental prosthesis can be mounted in the notch 111 of the conventional dental implant device 1. Therefore, such dental implant operation is relatively time-consuming and is uncomfortable for the patient.

Moreover, if the patient's alveolar bone 100 has a low bone mineral density or is formed with defects 101, it is more difficult to connect firmly the conventional dental implant device 1 to the alveolar bone 100 for the subsequent procedures of the dental implant operations.

Referring to FIG. 2, in order to alleviate the above drawbacks, Taiwanese Patent Publication No. 557211 discloses previously patented dental implant device 13 comprising a hollow main body 132 that is formed with a plurality of through holes 131 and that is disposed for receiving solidified calcium phosphate cement 14.

The solidified calcium phosphate cement 14 increases the growing speed of the alveolar bone 100 to shorten the dental implant operation time, and enhances the connecting strength between the alveolar bone 100 and the dental implant device 13. However, the filling of the calcium phosphate cement 14 in the hollow main body 132 prior to the implantation of the dental implant device 13 to the alveolar bone 100 results in inconvenience.

Moreover, since the calcium phosphate cement 14 is solidified, it is unable to be filled into the empty spaces 101 of the alveolar bone 100. Therefore, it still takes at least 1.5 to 3 months waiting time for growth of the alveolar bone 100 to connect to the calcium phosphate cement 14 through the through holes 131 in the hollow main body 132 of the dental implant device 13. Referring to FIG. 3, there is shown another embodiment of the previously patented dental implant device 13 disclosed in Taiwanese Patent Publication No. 557211. The solidified calcium phosphate cement 14 filled in the main body 132 is accessible through the through holes 131.

### SUMMARY OF THE INVENTION

Therefore, the object of the present invention is to provide a dental implant device capable of alleviating the above drawbacks of the prior art.

Accordingly, a dental implant device of the present invention is adapted for use in dental implant operations to engage the dental prosthesis. The dental implant device includes a hollow main body and an external thread. The hollow main body has top and bottom ends, an inner peripheral surface disposed between the top and bottom ends and defining a through hole extending through the top and bottom ends and adapted to engage the dental prosthesis, and an outer peripheral surface disposed between the top and bottom ends and surrounding the inner peripheral surface. The external thread is provided on the outer peripheral surface of the main body.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a conventional dental implant device implanted to an alveolar bone;

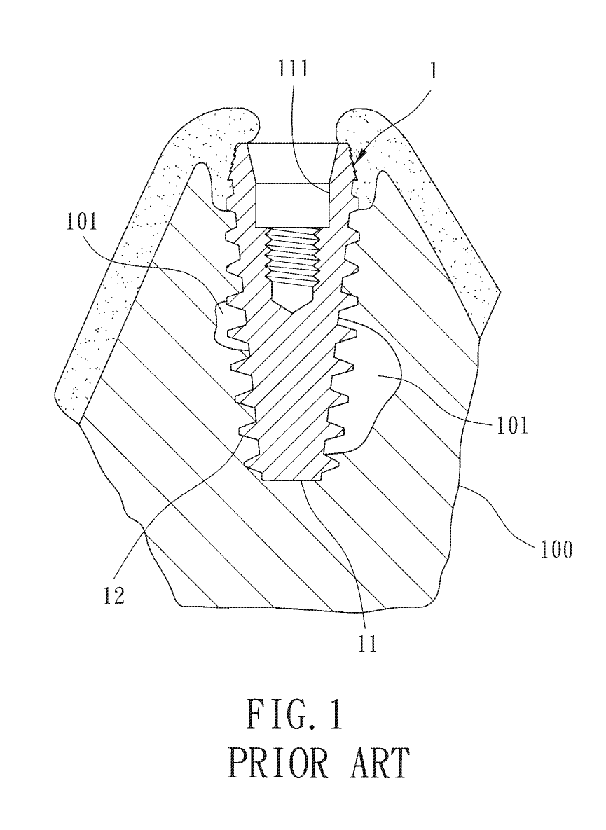

FIG. 2 is a sectional view of another previously patented dental implant device disclosed in Taiwanese Patent Publication No. 557211 implanted to the alveolar bone;

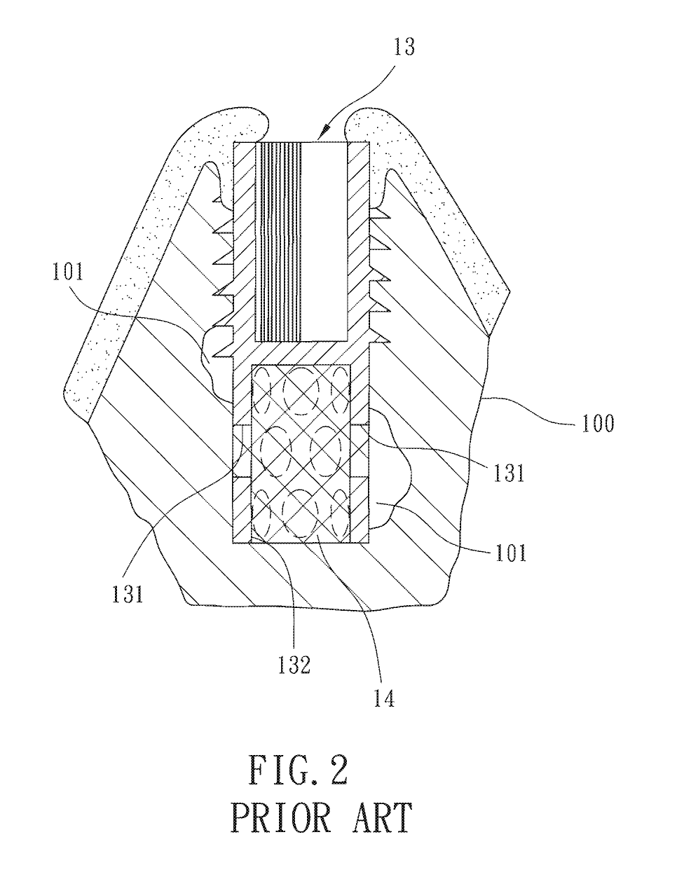

FIG. 3 is a sectional view of another embodiment of the previously patented dental implant device disclosed in Taiwanese Patent Publication No. 557211;

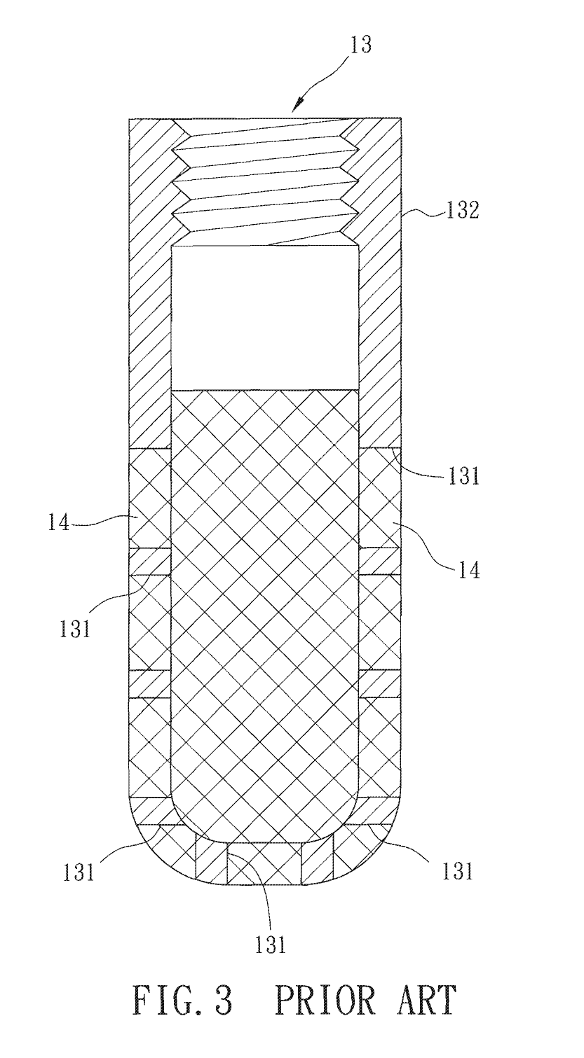

FIG. 4 is a sectional view of a first preferred embodiment of a dental implant device according to the present invention;

FIG. 5 is another sectional view of the first preferred embodiment implanted to an alveolar bone, illustrating how a gel additive is injected into the dental implant device;

FIG. 6 is yet another sectional view of the first preferred embodiment, illustrating how the dental implant device engages the dental prosthesis;

FIG. 7 is a sectional view of the first preferred embodiment, illustrating how the empty spaces of the alveolar bone are filled with the gel additive;

FIG. 8 is a sectional view of a second preferred embodiment of a dental implant device according to the present invention; and

FIG. 9 is a sectional view of a third preferred embodiment of a dental implant device according to the present invention.

### DETAILED DESCRIPTION OF THE PREFERRED EMBODIMENTS

Before the present invention is described in greater detail, it should be noted that like elements are denoted by the same reference numerals throughout the disclosure.

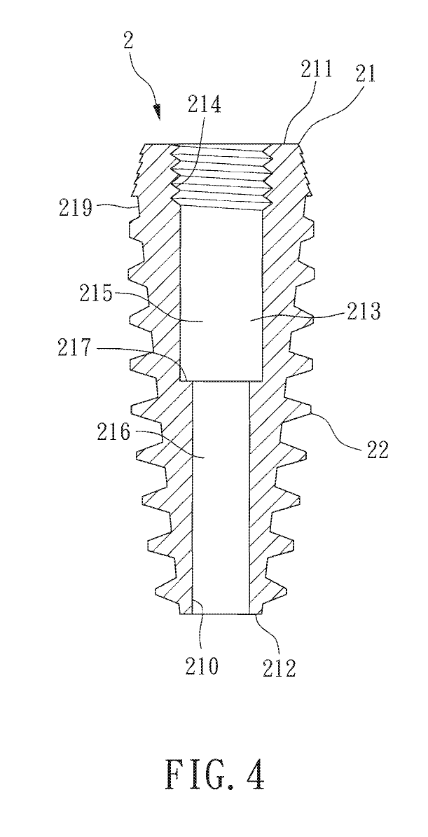

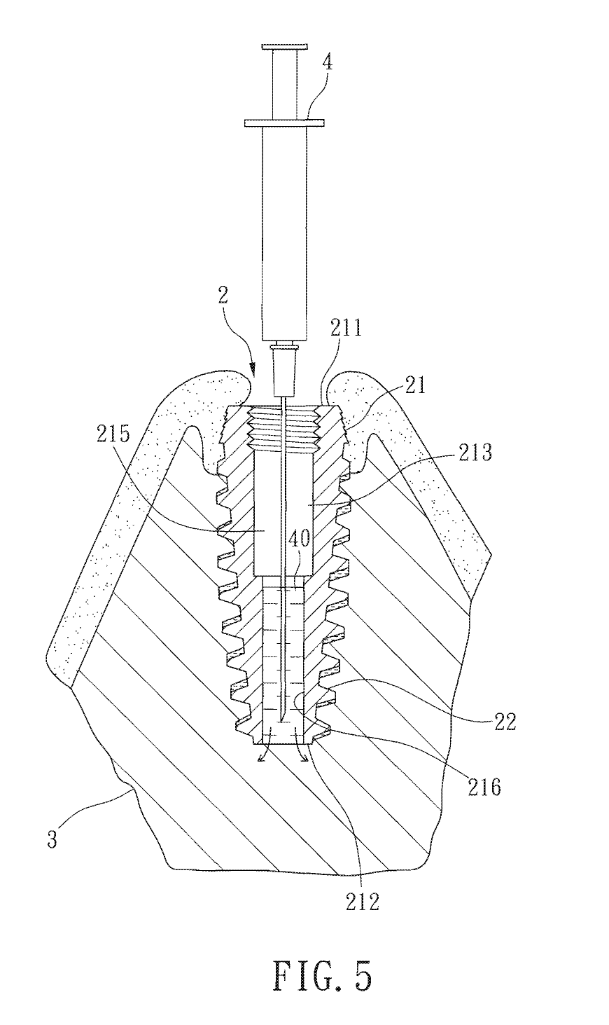

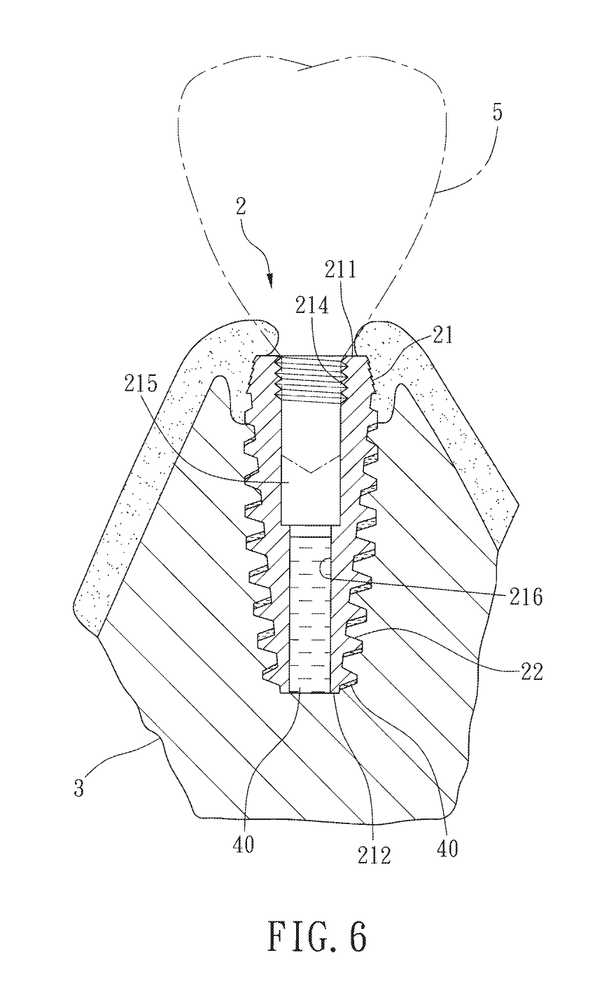

As shown in FIGS. 4 and 5, a first preferred embodiment of a dental implant device 2 according to the present invention is adapted for use in dental implant operations to engage the dental prosthesis 5 (see FIG. 6). The dental implant device 2 comprises a through and through hollow main body 21 and an external thread 22.

The hollow main body 21 has top and bottom ends 211, 212, an inner peripheral surface 210 that is disposed between the top and bottom ends 211, 212 and that defines a through hole 213 extending through the top and bottom ends 211, 212, and an outer peripheral surface 219 that is disposed between the top and bottom ends 211, 212 and that surrounds the inner peripheral surface 210. The external thread 22 is provided on the outer peripheral surface 219 of the main body 21.

The through hole 213 has a first hole portion 215, a second hole portion 216, and a shoulder portion 217. The first hole portion 215 is proximate to the top end 211 of the main body 21. The second hole portion 216 is distal from the top end 211 of the main body 21 and has a diameter smaller than that of the first hole portion 215. The shoulder portion 217 is formed between the first and second hole portions 215, 216.

The inner peripheral surface 210 of the main body 21 is formed with a first engaging component 214 located at the first hole portion 215, proximate to the top end 211 of the main body 21, and adapted to engage the dental prosthesis 5. In this preferred embodiment, the first engaging component 214 is configured as an internal thread.

Referring to FIGS. 5 and 6, during the dental implant operation, the hollow main body 21 is implanted into an alveolar bone 3 of a patient such that the alveolar bone 3 surrounds the external thread 22 of the hollow main body 21. Subsequently, a gel additive 40 is injected into the second hole portion 216 using an injector 4 through the first hole portion 215. The gel additive 40 then flows outwardly of the hollow main body 21 through the bottom end 212 into gaps between the external thread 22 and the alveolar bone 3, and flows upwardly to surround the external thread 22 due to the capillarity phenomenon.

The gel additive 40 can be made of injectable graft (e.g., calcium phosphate cement or calcium sulfate cement), stem cells, or a mixture having both. Since the ingredient of injectable graft is similar to the alveolar bone 3, the connection between the alveolar bone 3 and the injectable graft can be built quickly, such that the time of the dental implant operation is shortened while the connecting strength therebetween is enhanced. The stem cells mixed with injectable graft can facilitate the growth speed of the alveolar bone 3 that surrounds the dental implant device 2.

Clinical practice shows that, 30 minutes after injection of the gel additive 40, the connection between the alveolar bone 3 and the hollow main body 21 is strong enough to permit the dental prosthesis 5 to engage threadedly the first engaging component 214 for chewing. Compared to the conventional dental implant devices, the dental implant operation time can be effectively shortened.

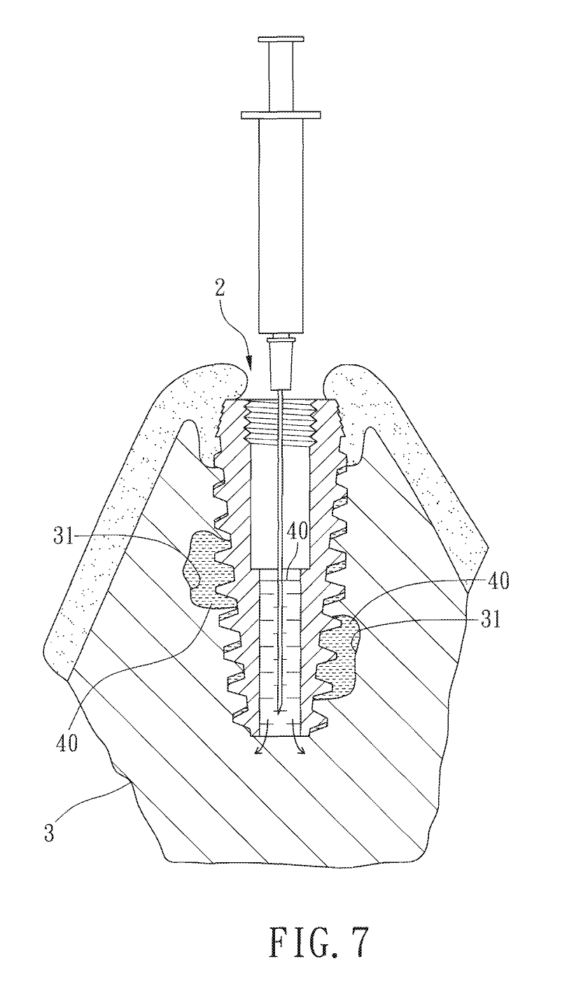

It should be noted that, since the gel additive 40 is in liquid state, if two empty spaces 31 exist in the alveolar bone 3 (see FIG. 7), the gel additive 40 can flow to fill up the empty spaces 31 to thereby enhance the connecting strength between the alveolar bone 3 and the dental implant device 2.

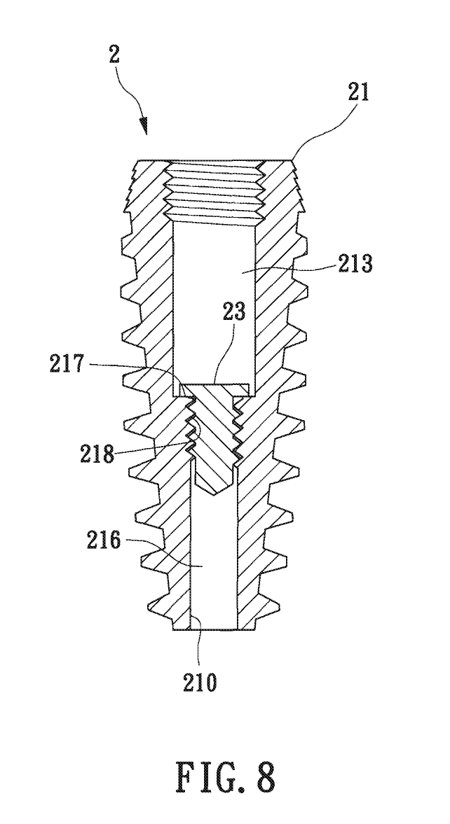

Referring to FIG. 8, a second preferred embodiment of the dental implant device 2 according to the present invention has a structure similar to that of the first embodiment. The main difference between this embodiment and the first embodiment resides in the following. The inner peripheral surface 210 of the hollow main body 21 is further provided with a second engaging component 218 in the second hole portion 216 of the through hole 213. The dental implant device 2 further comprises a block member 23 engaging detachably the second engaging component 218 and abutting removably against the shoulder portion 217. In this embodiment, the second engaging component 218 is configured as an internal thread, and the block member 23 is configured as a bolt. The block member 23 is provided to block the second hole portion 216 and to prevent backflow of blood during the implantation of the hollow main body 21. The block member 23 can be easily removed to permit subsequent injection of the gel additive 40. The second preferred embodiment has the same advantages as those of the first preferred embodiment.

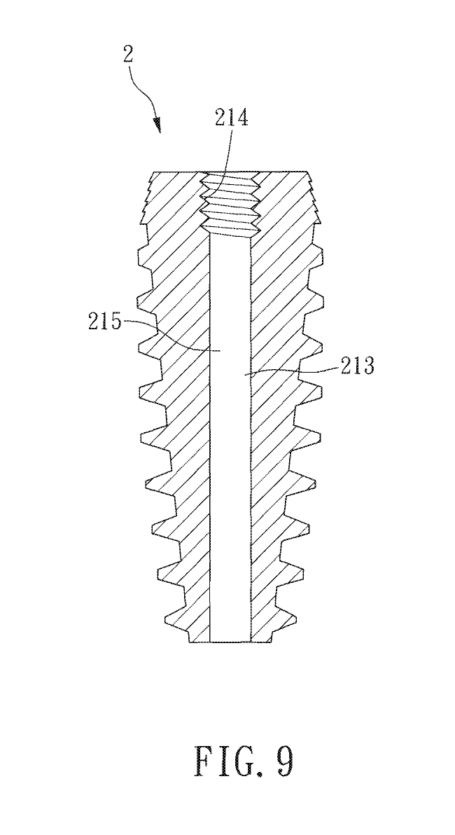

Referring to FIG. 9, a third preferred embodiment of the dental implant device 2 according to the present invention has a structure similar to that of the first embodiment. The main difference between this embodiment and the first embodiment resides in the following. The through hole 213 has only the first hole portion 215 which is formed with the first engaging component 214. Since the first hole portion 215 has a uniform diameter, the manufacturing cost can be reduced. The third preferred embodiment has the same advantages as those of the first preferred embodiment.

To sum up, the advantages of the dental implant device 2 according to the present invention are as follows. By virtue of the gel additive 40 such as injectable graft, stem cells or mixtures of both injected into the through hole 213, the dental implant operation time can be shortened and the connection between the alveolar bone 100 and the dental implant device 2 can be enhanced.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A dental implant device adapted for use in dental implant operations to engage the dental prosthesis, said dental implant device comprising:
a hollow main body having top and bottom ends, an inner peripheral surface that is disposed between said top and bottom ends and that defines a through hole extending through said top and bottom ends and adapted to engage the dental prosthesis, and an outer peripheral surface that is disposed between said top and bottom ends and that surrounds said inner peripheral surface; and
an external thread provided on said outer peripheral surface of said main body.

2. The dental implant device as claimed in claim 1, wherein said inner peripheral surface of said main body is formed with a first engaging component proximate to said top end of said main body and adapted to engage the dental prosthesis.

3. The dental implant device as claimed in claim 2, wherein:
said through hole has a first hole portion proximate to said top end of said main body, and a second hole portion distal from said top end of said main body and having a diameter smaller than that of said first hole portion; and
said first engaging component is located at said first hole portion.

4. The dental implant device as claimed in claim 3, wherein said first engaging component is configured as an internal thread.

5. The dental implant device as claimed in claim 3, wherein:
said through hole further has a shoulder portion formed between said first and second hole portions;
said inner peripheral surface is further provided with a second engaging component in said second hole portion of said through hole; and
said dental implant device further comprises a block member engaging detachably said second engaging component and abutting removably against said shoulder portion.

6. The dental implant device as claimed in claim 5, wherein said second engaging component is configured as an internal thread, and said block member is configured as a bolt.
